(19) United States
(12) Patent Application Publication
(10) Pub. No.: US 2009/0024441 A1
(43) Pub. Date: Jan. 22, 2009

(54) APPARATUS AND METHODS FOR INFORMATION SHARING ACROSS ORGANIZATIONS

(76) Inventor: MEHRAN MEHREGANY, Pepper Pike, OH (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/039,638

(22) Filed: Feb. 28, 2008

Related U.S. Application Data
(63) Continuation of application No. 10/446,904, filed on May 27, 2003, now abandoned.
(60) Provisional application No. 60/383,684, filed on May 24, 2002.

(51) Int. Cl. G06Q 10/00

(52) U.S. Cl. 705/9; 705/7

(57) ABSTRACT

A method of leveraging disperse expertise is disclosed. The method comprises identifying a problem to be solved; searching a database of experts; locating one or more experts to solve the problem; reviewing a profile of each of the one or more experts located in the search; drafting a request for proposal information/request for information which includes a discussion of the problem; sending the request for proposal/request for information to the team of experts; receiving responses to the request for proposals/request for information from the team of experts; and utilizing the response to help find a solution to the problem.

### CROSS-REFERENCE TO RELATED APPLICATION

This application is a continuation of and claims priority to U.S. patent application Ser. No. 10/446,904, filed May 27, 2003, the disclosure of which is incorporated herein by reference in its entirety for all purposes.

### TECHNICAL FIELD OF THE INVENTION

This invention relates to the field of employee collaboration and more specifically to a system and method for sharing information across organizations.

### BACKGROUND OF THE INVENTION

In business organizations talent and ideas are spread out amongst various regional offices, departments, business units, research teams and the like. While divisions such as these serve various business-oriented goals, they can lead to gross inefficiencies. For example, an individual assigned to a particular business unit may encounter a problem where at least part of the solution may have been already considered or solved in another business unit. Or, unbeknownst to the individual, there exists one or more experts within the organization that would be ideal to work on the problem. Because of the division within the organization the individual never learns about the experts or efforts previously made to solve the problems. Thus, the individual essentially reinvents the wheel to solve the problem. This results in a great inefficiency.

What is needed is a simple way for an organization to identify experts and solutions across the organization and to utilize the experts and solutions in solving new problems.

### SUMMARY OF THE INVENTION

In one embodiment a method of leveraging disperse expertise is disclosed. The method comprises identifying a problem to be solved; searching a database of experts; locating one or more experts to solve the problem; reviewing a profile of each of the one or more experts located in the search; drafting a request for proposal information/request for information which includes a discussion of the problem; sending the request for proposal/request for information to the team of experts; receiving responses to the request for proposals/request for information form the team of experts; and utilizing the response to help find a solution to the problem.

Therefore, a more efficient way of collaborating and sharing information is disclosed.

### BRIEF DESCRIPTION OF THE DRAWINGS

Non-limiting and non-exhaustive preferred embodiments of the present invention are described with references to the following figures wherein like reference numerals refer to like parts throughout the various views unless otherwise specified.

FIG. 1 is a block diagram of a system for sharing information

FIG. 2 is a black diagram of the functionality of the innovation management software;

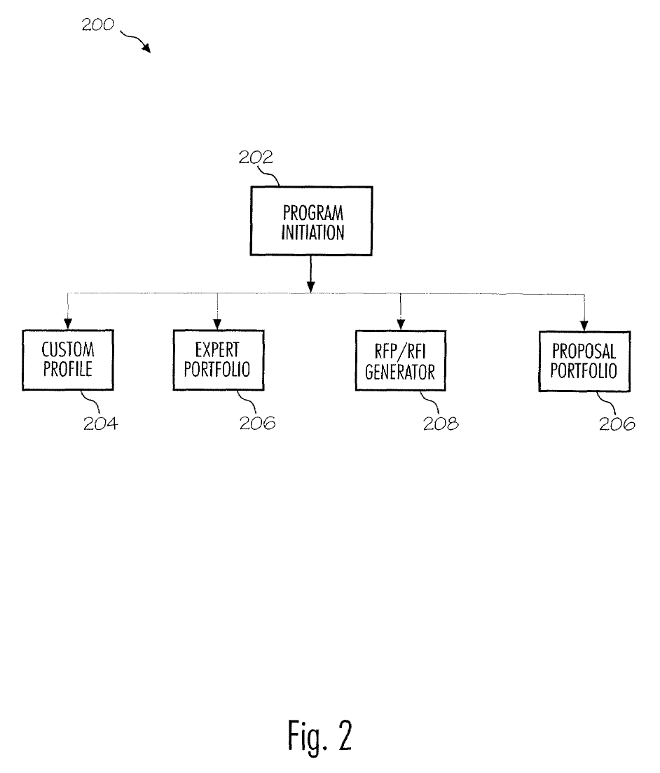

FIG. 3 is an exemplary My Profile page;

FIG. 4 is an exemplary search page;

FIG. 5 is a an exemplary expert portfolio page;

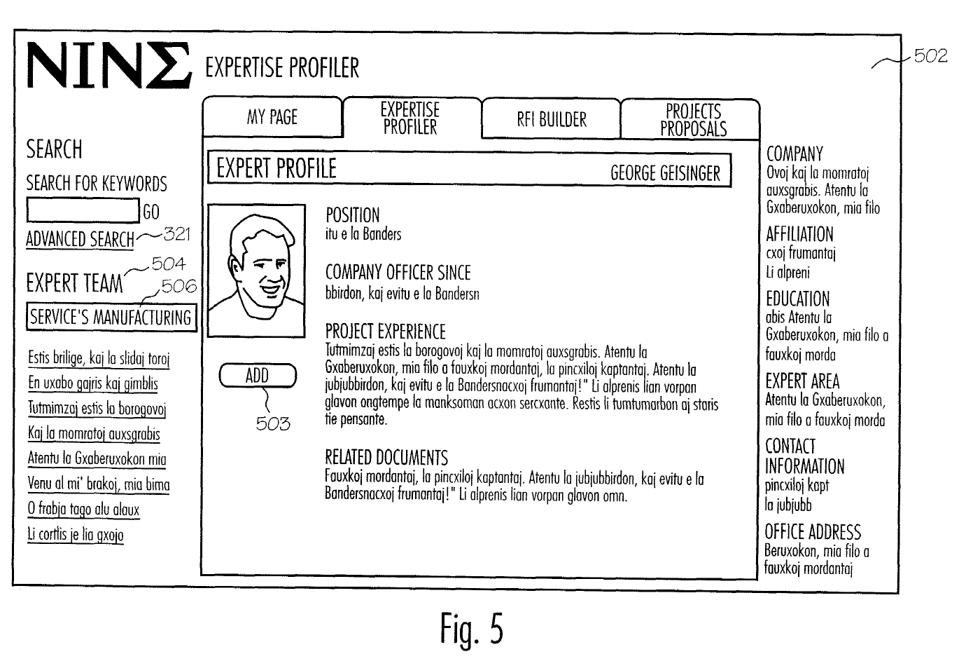

FIG. 6 is an exemplary RFP/RFI builder page;

FIG. 7 is an exemplary proposal portfolio page; and,

FIG. 8 is a flowchart demonstrating the formation of an expert team.

### DETAILED DESCRIPTION OF THE DRAWINGS

A method and system for sharing information across an organization is disclosed. In the method, a user searches for experts in a specific discipline within the organization or between organizations that matches a criteria set by the user. The user reviews the profile of each expert located and determines which ones are to be added to a team of experts. The user then can send email to each of the identified experts with information regarding the user's problem or a request for information. This can be an informal email or can be a formal request for proposal/request for information generated as part of the program. In response to the request for proposal/request for information, members of the team of experts may send information and proposals back to the user.

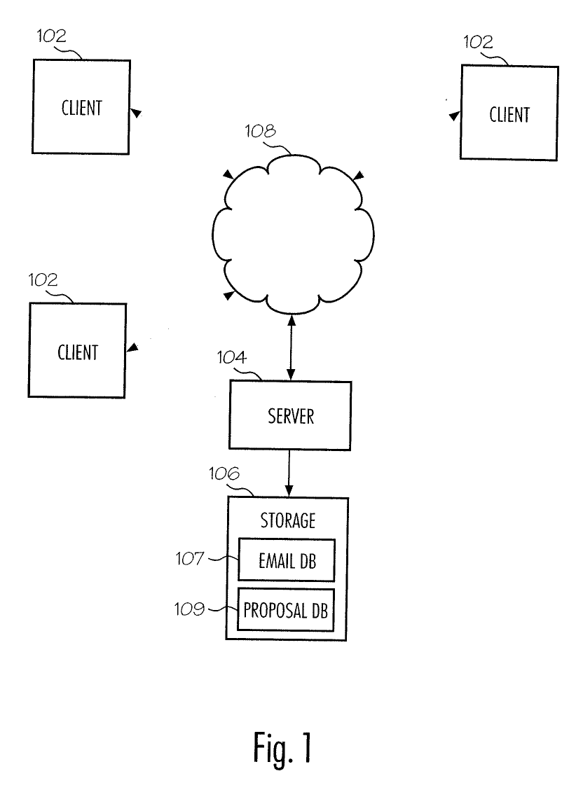

FIG. 1 is a block diagram of an exemplary system 100 for sharing information across an organization. The system 100 includes a plurality of client computers 102 coupled to a server computer 104 by a network 108. Server computer 104 couples to a storage system 106.

Client computer 102 is any computing device capable of connecting to a networked environment to perform such tasks as to access information stored on other computers on the network or to communicate with other computers connected to the network. Client computer may be a personal computer, a hand held computer or personal digital assistant and the like. Client computer 102, in one embodiment is a personal computer having a processor, a printer, an input device such as a keyboard and/or mouse, a monitor, a floppy disk drive, memory, a modem and/or computer network interface, and a mass storage device such as a hard disk drive and/or a readable/rewritable CD-ROM drive. Client computer 102 operates under the control of an operating system such as MS-DOS, WINDOWS 95/98/2000/NT/ME/XP, OS/2, UNIX, LINUX, MAC OS and the like. Client computer 102 is operable to run application programs including a web based application program, such as an innovation application program. In one embodiment, each client computers 102 are used by user in the same organization who may be in different organization groups and/or geographically dispersed. Alternatively, the users may be members of different organizations such as a company and one of its suppliers.

Web based programs are programs operable to run at least partially on client computer 102 with the remainder of the program functionality hosted on a web site. Web based programs communicate with server 104 using a protocol such as hypertext transfer protocol (HTTP). Web based programs are operable to receive information from server 104 or other clients computers 102. A web-based program 110 can locate a computer on the network to communicate with based on the network address of the computer and/or the uniform resource locator (URL) of a web page hosted on the computer. Information from the remote computer is then retrieved for use by client computer 102. In the present invention, the user of client computer 102 will utilize the web-based program 110 to access server 104 and store/retrieve information from storage system 106. In the present invention the web based application program is an innovative management program. While innovative management program is discussed as a web based program it can also be utilized as a non-web based program.

Server 104 is any computer device capable of operating in a networked environment and receiving data and files in response to request from client computers 102. Server 104, such as the AS/400 or I series by International Business Machines of New York, will typically including a memory, a processor, a network connection and the like. Server computer 104 operates under the control of an operating system such as OS/400 by International Business Machines of New York. Server 104 is operable to run application programs such as web hosting programs.

Storage system 106 is any device capable of storing computer files such as a hard drive, optical drive, tape drive and the like. In the present invention storage system 106 stores, among other things, an expert database 107 and a proposal database 109. The functionality of expert databases and proposal databases can be combined in to a single database. Data from these databases can be retrieved by receiving a request from server 104. Server 104 receives the request to retrieve data from individual client computers 102.

Network 108 is any computer network, public or private. In one embodiment, network 108 is the Internet. However, network 108 can be any intranet, extranet, wide area network, and the like, public or private. While the system has been shown with central server architecture, other architecture can be used, such as peer to peer network where client computers access each other directly without using a central server, can be used without departing from the scope of the present invention.

In operation, a user of client computer 102 who desires to find expertise for a project initializes the innovation management software 200. Various databases can then be queried in order to assemble a team of experts. Communications, including email and requests for proposals/requests for information, can be sent to experts who are utilizing other client computers 102 via network 104.

Upon initialization of the information management method, which in one embodiment employs innovation management software 200, four main functions are accessible. These functions are a customized user page 204, an expert portfolio 206, a request for proposal or request for information generator 208, and a proposal portfolio 210. These main functions may be divided into other sub-functions or additional functions can be added without departing from the scope of the present invention.

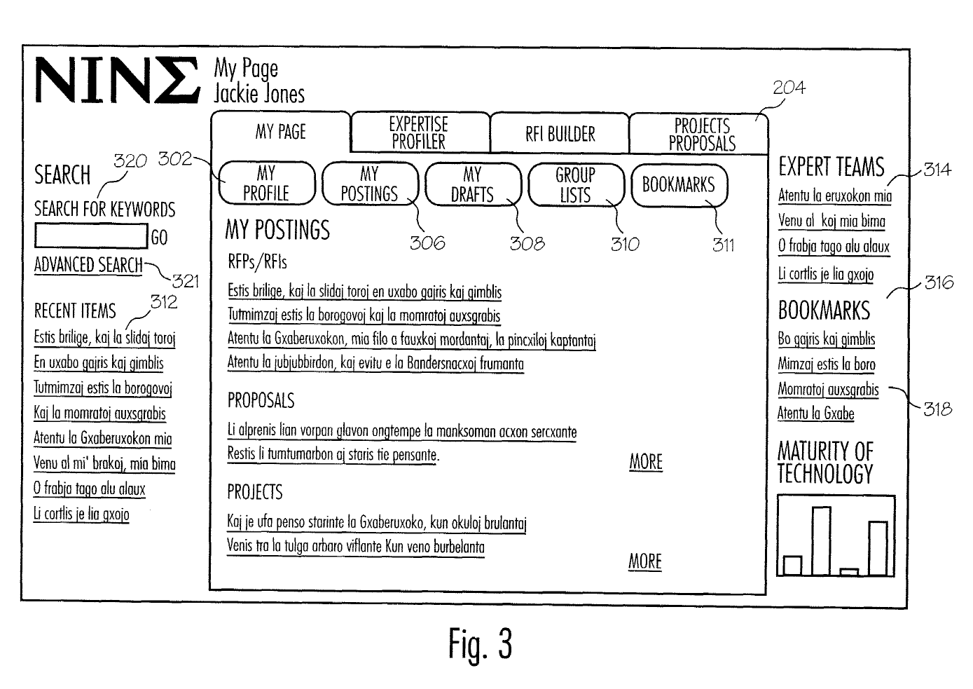

Customized user page 204, as seen in FIG. 3, provides the user with the ability to review personal postings, group affiliations and information. Customer user page 304 includes links to subsections including a my profile section 302, a my posting section 304, a my drafts section 306, a group listing section 308 and a bookmark section 311. My profile section 302 allows the user to enter personal information about himself/herself and his/her abilities, accomplishments, training, expertise and the like. This information can be searched for and viewed by other members of the organization when they search for talent and ability to work on a project. This information can be easily accessed by the user and updated.

My posting section 306 provides a listing of the different writings that the user has submitted. These can include request for proposals/information/project write-ups by the user and the like. The my posting page 306, in one embodiment, provides titles and/or synopsis of the writings with a link to the full text that in one embodiment, is stored in storage 106. My drafts section 308 is similar to my posting section 306 except the writing are drafts and not submitted proposals.

Group listing section 310 lists the individuals in each project group. These individuals are the expert team for the project. The listing includes such information as the name of the individual, address, location of the business unit, email address and the like. By gathering all experts and project personnel listing for each project in one area, the user is able to compose and send email messages and requests to the entire group and/or team of experts at once. This helps provide for an efficient way of communicating to all members of a project and sharing knowledge across an organization. Providing the ability to track different projects and their team members also provides a more efficient contact and development system.

Bookmark section 311, when selected, provides a listing of different web sites that are of interest to the user. For instance, if the user is working on a project involving nuclear engineering, different web pages from the Nuclear Regulatory Commission web site may be listed in the bookmark section 311. The bookmarks can be listed as the name of an article or web site that the user could point his/her mouse over to click on to have a web browser locate that article or the URL of the article can be listed.

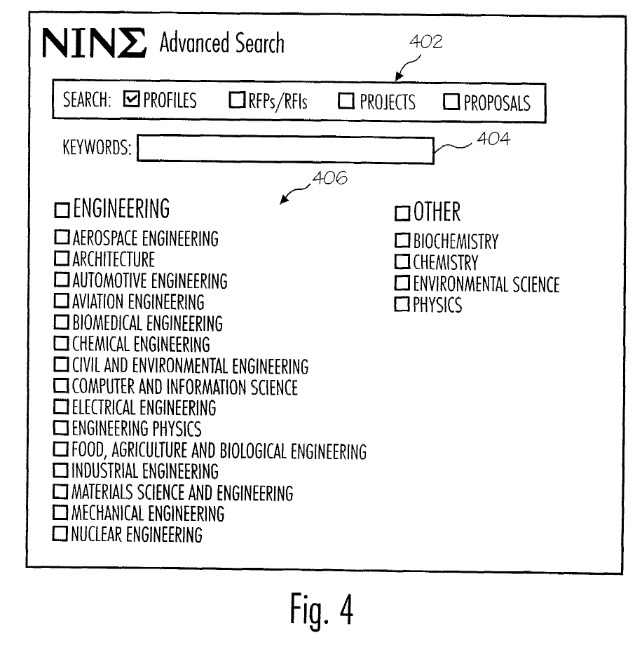

From the custom user page 204 the user can initiate searches for expert profiles, request for proposals, projects and proposals. FIG. 4 illustrates an advance search screen 400 that can be retrieved by selecting the advance search tag 321. Selecting advance search tag 321 will call up advance search screen 400. In one embodiment advance search screen 400 includes search selection 402. Search selection 402 allows the user to select the category of item for which to search. As an example the categories can be individual profiles, requests for proposals, projects and proposals. Other categories can be added to or replace categories from this list without departing from the scope of the invention. In one embodiment, search screen 400 includes a key work search box 404. The user enters keywords to be searched for into the box and then initiates the search. Search limiters 406 allow the user to select limiting terms that will allow keyword searching to occur only with the terms selected. For example, the user may want to search for experts in nuclear engineering associated with the keyword “shielding”. The user would select nuclear engineering as a limiter in the search limiter 406. The user would then type the word “shielding” into keyword search box 404. By initializing the search, the database of all individual profiles would be searched for the files that list nuclear engineering as a specialty and for the keyword “shielding”. Any expert in shielding as it pertains to nuclear engineering will be thus located. The keyword and expert listing are entered by each user of the system when entering personnel information into the my profile section 302.

Information regarding experts that are located through a search can be viewed, in one embodiment in expertise profiler 206. Expertise profiler 206 includes an individual profile section 502, a team listing 504 of experts, typically grouped by expertise 506. Individual profile section 502 includes information such as the name, affiliation, education, contact information and the like. Individual profile section 502 may also include links to documents concerning, authored by or otherwise related to the expert being profiled. Individual profile section 502 also includes an expert add button 503. Selection of expert add button 503 allows the user to add the currently viewed members to the expert team. Similar functionality can be provided to eliminate a team member.

Expert team section 504 provides a listing of members of the expert team by name with links to each members profile. Expert teams are organized by either expert area or team name as seen in expert grouping box 506.

Other sections related to expertise profiler 206 can be provided. For example, a page listing all expert areas with all team members can be provided. Additionally, the ability to select an expert team and send email or other communications to each team member simultaneously can be provided. Search screen 400 can be retrieved from this page by selecting advance search tag 321.

The members of a team can be selected via searching for profiles using the advance search screen 400. The profiles of those individuals located can then be reviewed by the user who can add individuals located in the server that he/she wants to have on team. Profiles can also be sent to the users by individuals who learn of the user's activity and interest via reading the user's request for proposals or request for interest, review previous proposals, project proposals or by some other means.

After the expert team is selected, the user typically generates a request for proposal/request for information that is then sent to a distribution list such as a list of team members.

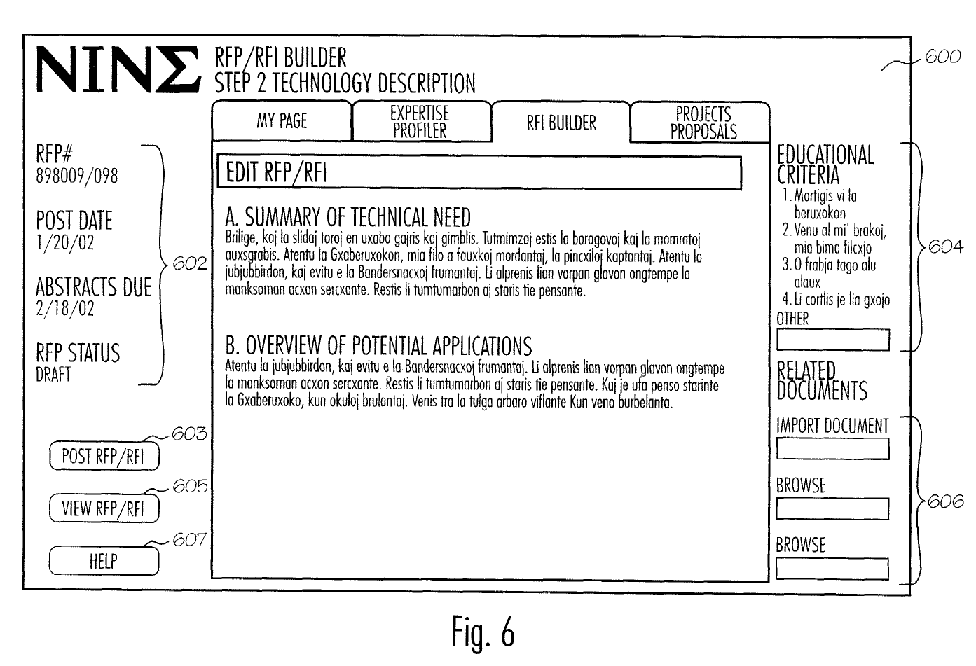

In one embodiment, the request for proposal generating is done in five steps. An exemplary request for proposal/request for information page 600 is shown in FIG. 6. First, the basic details of the RFP/RFI are identified such as the title of the proposal, the expected budget of the proposal, the duration of the proposal/project, the date the project has been posted and the due date for any response. Part of this information is shown in section 602 of FIG. 6. Next, the technical description for the request for proposal/request for information is entered. In this section, the technical objective and needs of the problem to be addressed by the request for proposal/request for information is drafted. A discussion of tried solutions can be discussed as well as a potential solutions path. Other information such as an overview of particular applications can be provided.

Next, the distribution list for the RFP/RFI is defined. The distribution list can be the same as, or a subset of, the expert team members. Or another predefined list of individuals can be selected. Additionally, new individuals not previously identified can be selected by performing searches based on specific key words. In the next step, any individuals within an organization that are responsible for reviewing proposals or approving proposals are identified and defined. Specific groups of individuals can also be excluded from the distribution list. This is needed when the experts are spread across different organizations and the RFP/RFI is sent for one organization only. Lastly, in a fifth step, the RFP/RFI is finalized. Finalization includes sending the RFP/RFI to the individuals in the distribution list for review, sending the RFP/RFI to any review team for review and approval and/or sending the final version for storage in the proposal database 109 for searches and viewing by other users.

The review of the RFP/RFI by team members and others allow for the integrating of comments and viewpoints from other individuals to help make a better RFP/RFI and final proposal. The five steps discussed in this method to create the RFP/RFI is for exemplary purposes only and steps can be added to or subtracted from or substituted for the listed steps without departing from the scope of the present invention. The generation of RFP/RFI using a standardized format provides a method for the user and team member to develop and fine tune the proposal even though the team members may be geographically dispersed and working in different divisions, business unit or other organizational division whether they be inter or intra organizational divisions.

RFP/RFI screen 600 also includes a RFP/RFI summary section 602, an evaluation criteria list 604 and a related document section 606. The RFP/RFI summary section 602 provides basic information regarding the RFP/RFI including pertinent due dates and milestones. Evaluation criteria 604 provides a listing of criteria that individuals should use in evaluating the RFP/RFI. Related documents section 606 allows the users to insert documents, Internet URLs and other related information regarding the RFP/RFI to be distributed with the RFP/RFI. For example, pertinent photos, graphs or background documents can be added. When the RFP/RFI is sent, the additional documents are included. The RFP/RFI can be posted to its distribution list by selecting post RFP/RFI button 603. A draft of the RFP/RFI can be displayed by selecting view response button 605.

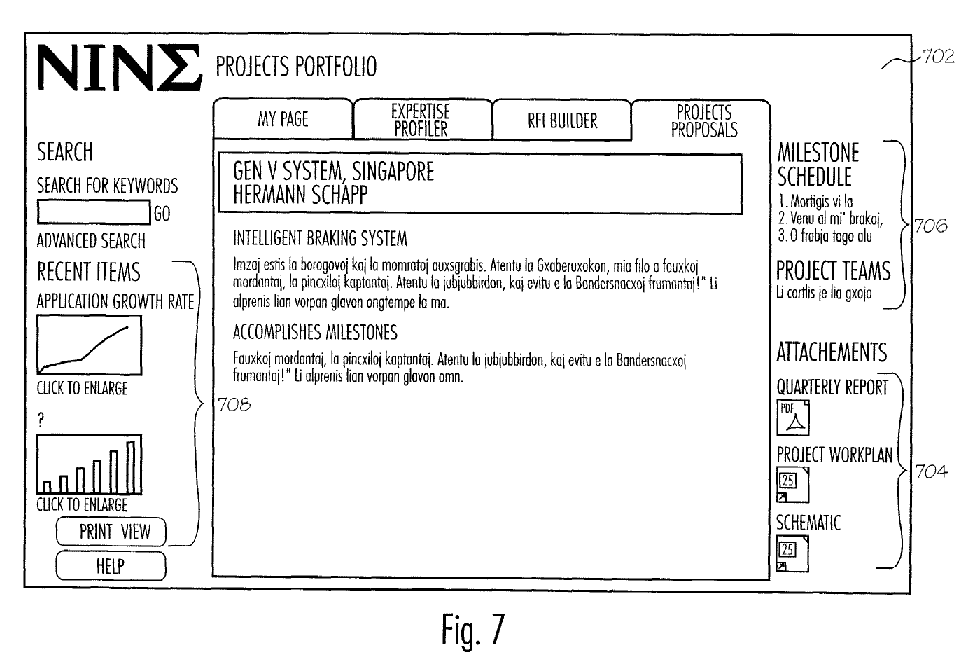

After submitting the RFP/RFI to members of the team, the user, in addition to comments regarding the RFP/RFI may also receive proposals or information. These proposals can be reviewed using project portfolio 208 as illustrated in FIG. 7. Project portfolio 208 includes information such as the name of the proposal's author and a description of the proposals. The proposal may also include proposal attachments 704 that are related to the proposal. A listing 706 of the project team may also be provided. Recent items added to the proposals can be delineated in a recent item list 708.

Not only is project portfolio 208 used to review proposals sent in response to an RFP/RFI, it can also be used to review proposals located in a search of proposals, such as one done using advance search screen 400.

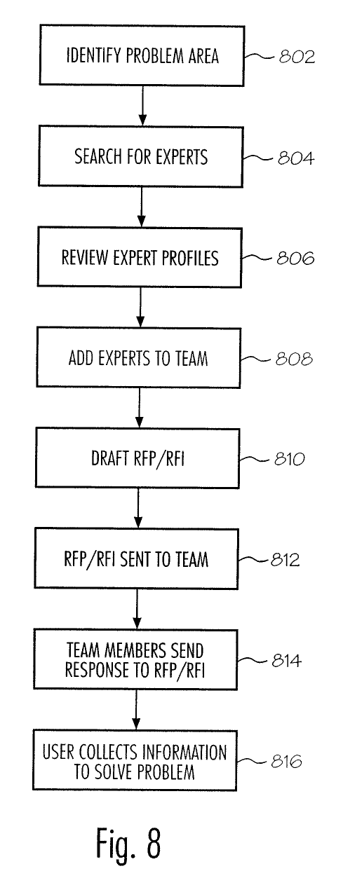

A method, illustrated by the flowchart of FIG. 8, for the sharing of information initializing includes identifying the problem area, step 802. Identifying the problem area allows the user to formulate what qualities or expertise are needed in the experts for his/her team.

Next, in step 804, the user searches for individuals to form the expert team for the problem identified in step 802. The search can be done using keywords identified when framing the problem and the searches can be limited to certain categories such as specific engineering disciplines. The information searched is typically stored in an expert database.

The profile of each of the experts found in step 804 are reviewed in step 806. The profile may include such information as demographical information, professional and educational history information, experience information and the like. In step 808, the user can add any of the experts located in step 804 to the expert team.

After the expert team is identified, in step 810, the user will draft an RFP/RFI listing such things as the technical expertise needed, application of potential products, due dates and the like. In step 812, the RFP/RFI is sent to the team members.

The team members review the RFP/RFI and, in step 814, sends information in response to the RFP/RFI. The information may include short comments or large discussions. These ideas help to finalize the RFP/RFI. The response may also include a project or proposal or a way to retrieve a project or proposal selected to the RFP/RFI. The project or proposal may be retrieved via a link or by providing keywords to be used to search for the proposal or project. The project may include information regarding other work that may be related to the problem area. The proposal may include proposed solutions that might apply to the problem area.

In step 816, the user collects all information received and uses the information to improve the RFP/RFI and to help find a solution to the problem.

The above method allows for a user with a technical challenge to reach beyond his/her limited area (limited by geography or expertise) and locate and communicate with experts within the same organization that can help solve the problem. Thus, knowledge or expertise within an organization is leveraged.

While the method of FIG. 8 was based on individuals within the same organization, the same method can be used between individuals in different organizations. For example, suppliers of an organization can be team experts. Also, members of specialized organizations such as specialized research or consulting organizations can be team members.

What is claimed:

1. A method of leveraging disperse expertise comprising: a) identifying a problem to be solved; b) searching a database of experts; c) locate one or more experts to solve the problem d) reviewing a profile of each of the one or more experts located in the search; e) drafting a request for proposal information/request for information which includes a discussion of the problem; f) sending the request for proposal/request for information to the team of experts; g) receiving responses to the request for proposals/request for information form the team of experts; and h) utilizing the responses to help find a solution to the problem.

2. The method of claim 1 wherein the step of searching a database of experts further comprises using keyword search and search limitations to search a database of experts.

3. The method of claim 1 further comprising the step of receiving information about a member of the organization and storing it in a profile in the expert database.

4. The method of claim 1 wherein the step of generating a request for proposal/request for information further comprises using a predefined template to generate the request for proposal/request for information.

5. The method of claim 1 wherein the step of drafting a request for proposal/request for information further comprises attaching supporting documents to the request.

6. The method of claim 1 wherein all the individuals are employed by a first organization.

7. The method of claim 1 wherein some of the individuals are employed by a first organization and some by a second organization, the team of experts including individuals from the first organization and the second organization.

8. A system for locating experts to facilitate problem solving comprising: a server computer having a processor and memory the sever operable to: a) receive a request to search a database of experts; b) send a listing of profiles for each expert located in the search; c) receive and store a listing of a team of experts selected from the listing of profiles; d) distribute a request for proposal/request for information to a distribution list including one or more of the team members; and e) distribute responses to the request for proposal/request for information to the author of the request for proposal/request for information.

9. The system of claim 8 wherein the step of searching a database of experts further comprises using keyword search and search limitations to search a database of experts.

10. The system of claim 8 further comprising the step of receiving information about a member of the organization and storing it in a profile in the expert database.

11. The system of claim 8 wherein a predefined template is used generate a request for proposal/request for information further comprises using generate the request for proposal/request for information.

12. The system of claim 8 wherein supporting documents are attached to the request for proposal/request for information.

13. The system of claim 8 wherein all the individuals are employed by a first organization.

14. The system of claim 8 wherein some of the individuals are employed by a first organization and some by a second organization, the team of experts including individuals from the first organization and the second organization.

15. A system for facilitating the location and utilization of experts comprising: a personal information component, the personal information component allowing a user to store information regarding the users expertise and experience; an expert profile component, the expert profile component allowing the user to review the information regarding other user's expertise and experience; a request for proposal/request for information, the request for proposal/request for information generator providing the user a template to draft requests for proposals/request for information and send the request for proposal/request for information to a selected distribution list; and a proposal profile component, the proposal profile component providing the user with access to proposals sent in response to the request for proposal/request for information.

16. The system of claim 15 wherein keyword searches and search limitations are used to search a database of experts.

17. The system of claim 15 wherein information about a member of the organization is collected and stored in a profile in the expert database.

18. The system of claim 15 wherein the step of drafting a request further comprises attaching supporting documents are attached to the request for proposal/request for information.

19. The system of claim 15 wherein all the individuals are employed by a first organization.

20. The system of claim 15 wherein some of the individuals are employed by a first organization and some by a second organization, the team of experts including individuals from the first organization and the second organization receiving from a buyer a search request based on one or more search criteria, the search request initiating a search of the central database for abstracts that meet the search criteria; returning a list of abstract that match the search criteria to the buyer.
